(19) United States
(12) Patent Application Publication
(10) Pub. No.: US 2021/0289141 A1
(43) Pub. Date: Sep. 16, 2021

(54) CONTROL METHOD AND APPARATUS FOR PHOTOGRAPHING DEVICE, AND DEVICE AND STORAGE MEDIUM

(71) Applicant: SZ DJI TECHNOLOGY CO., LTD., Shenzhen (CN)

(72) Inventors: Jie QIAN, Shenzhen (CN); Xiaodong GUO, Shenzhen (CN); Qifeng WU, Shenzhen (CN)

(21) Appl. No.: 17/334,735

(22) Filed: May 29, 2021

Related U.S. Application Data
(63) Continuation of application No. PCT/CN2018/118410, filed on Nov. 30, 2018.

(51) Int. Cl. H04N 5/232; B64C 39/02

(52) U.S. Cl. CPC H04N 5/23296; B64C 2201/127; B64C 39/024; H04N 5/23218

(57) ABSTRACT

A control method for a photographing device mounted on a mobile platform, including: obtaining photographing information of the photographing device and monitoring information of a target object, that the target object is a photographing object of the photographing device; and in response to detecting a trigger event of identifying the target object, controlling a zoom operation of the photographing device according to the photographing information and the monitoring information, a size of the target object in an image acquired by the photographing device being controlled within a preset range according to the zoom operation.

### CROSS-REFERENCE TO RELATED APPLICATION

This application is a continuation of International Application No. PCT/CN2018/118410, filed Nov. 30, 2018, the entire content of which is incorporated herein by reference.

### TECHNICAL FIELD

The present disclosure relates to the field of unmanned aerial vehicles and, more particularly, to a control method and apparatus for a photographing device, a device, and a storage medium.

### BACKGROUND

Existing mobile platforms, such as mobile robots, unmanned aerial vehicles, handheld gimbals, etc., are equipped with photographing devices. A user can control a focal length of a photographing device to adjust a size of a target object in an image acquired by the photographing device.

However, if the size of the target object in the image is too large or too small, accurate identification cannot be performed for the target object in the image.

### SUMMARY

In accordance with the disclosure, there is provided a control method for a photographing device mounted on a mobile platform, including: obtaining photographing information of the photographing device and monitoring information of a target object, that the target object is a photographing object of the photographing device; and in response to detecting a trigger event of identifying the target object, controlling a zoom operation of the photographing device according to the photographing information and the monitoring information, a size of the target object in an image acquired by the photographing device being controlled within a preset range according to the zoom operation.

Also in accordance with the disclosure, there is provided a control apparatus for a photographing device, including: a memory; and a processor, that the memory is configured to store program codes; and the processor calls the program codes, and when the program codes are executed, the processor is configured to perform the following operations: obtaining photographing information of the photographing device and monitoring information of a target object, that the target object is a photographing object of the photographing device; and In response to detecting a trigger event of identifying the target object, controlling a zoom operation of the photographing device according to the photographing information and the monitoring information, a size of the target object in an image acquired by the photographing device being controlled within a preset range according to the zoom operation.

Also in accordance with the disclosure, there is provided a mobile platform, including: a vehicle body; a propulsion system, installed on the vehicle body and configured to provide propulsion; a photographing device, configured to acquire images; and a control apparatus for the photographing device, including: a memory; and a processor, that the memory is configured to store program codes; and the processor calls the program codes, and when the program codes are executed, the processor is configured to perform the following operations: obtaining photographing information of the photographing device and monitoring information of a target object, that the target object is a photographing object of the photographing device; and In response to detecting a trigger event of identifying the target object, controlling a zoom operation of the photographing device according to the photographing information and the monitoring information, a size of the target object in an image acquired by the photographing device being controlled within a preset range according to the zoom operation.

### BRIEF DESCRIPTION OF THE DRAWINGS

FIG. 1 is a schematic diagram of an application scenario according to an example embodiment of the present disclosure;

FIG. 2 is a flowchart of a control method for a photographing device according to an example embodiment of the present disclosure;

FIG. 3 is a flowchart of a control method for a photographing device according to another example embodiment of the present disclosure;

FIG. 4 is a schematic diagram of a target object according to an example embodiment of the present disclosure;

FIG. 5 is a schematic diagram of a target object according to another example embodiment of the present disclosure;

FIG. 6 is a schematic diagram of a target object according to another example embodiment of the present disclosure;

FIG. 7 is a flowchart of a control method for a photographing device according to another example embodiment of the present disclosure;

FIG. 8 is a schematic diagram of an application scenario according to another example embodiment of the present disclosure;

FIG. 9 is a structural diagram of a control apparatus for a photographing device according to an example embodiment of the present disclosure; and

FIG. 10 is a structural diagram of an unmanned aerial vehicle according to an example embodiment of the present disclosure.

### DETAILED DESCRIPTION OF THE EMBODIMENTS

Technical solutions of the present disclosure will be described with reference to the drawings. It will be appreciated that the described embodiments are part rather than all of the embodiments of the present disclosure. Other embodiments conceived by those having ordinary skills in the art on the basis of the described embodiments without inventive efforts should fall within the scope of the present disclosure.

It should be noted that when one component is referred to as being “fixed to” another component, the one component can be directly on the another component, or components may also exist between the one component and the another component. When one component is considered to be “connected” to another component, the one component can be directly connected to the another component, or components may also exist between the one component and the another component at a same time.

Unless otherwise defined, all technical and scientific terms used herein have the same meaning as commonly understood by those skilled in the technical field of the present disclosure. The terms used in the description of the present disclosure herein are only for the purpose of describing the embodiments, and are not intended to limit the present disclosure. The term “and/or” as used herein includes any and all combinations of one or more related listed items.

The embodiments of the present disclosure will be described in detail below with reference to the accompanying drawings. In the case of no conflict, the following embodiments and features in the embodiments can be combined with each other.

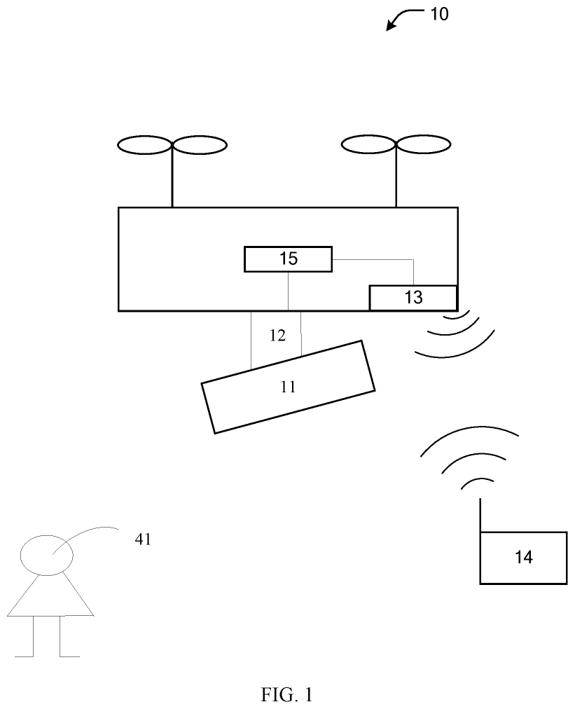

The embodiments of the present disclosure provide a control method for a photographing device. The control method for the photographing device is applied to a mobile platform, and the photographing device is mounted on the mobile platform. The mobile platform includes at least one of the following: an unmanned aerial vehicle (UAV), a mobile robot, or a handheld gimbal. The embodiments of the present disclosure take a UAV as an example to introduce the control method for the photographing device. As shown in FIG. 1, a UAV 10 is equipped with a photographing device 11. The photographing device 11 is connected to a vehicle body of the UAV 10 through a supporting member such as a gimbal 12, and an image acquired by the photographing device 11 can be sent to a ground control terminal 14 through a communication interface 13. 15 represents a processor in the UAV 10. The processor may be a flight controller of the UAV 10. The flight controller can be configured to control a flight of the UAV 10, for example, to control the UAV 10 to intelligently follow a target object 41. The ground control terminal 14 can be configured to control flight status parameters of the UAV 10, for example, to control a flight speed, a flight altitude, an attitude angle of the UAV 10, etc. In some embodiments, the ground control terminal 14 can also control photographing parameters of the photographing device 11 of the UAV 10, for example, control a focal length and resolution of the photographing device 11, etc.

In some embodiments, the ground control terminal 14 may be provided with a zoom component for adjusting the focal length of the photographing device 11, such as a zoom ring. The ground control terminal 14 generates a zoom instruction according to a user's operation on the zoom ring, and sends the zoom instruction to the photographing device 11. The photographing device 11 performs zooming according to the zoom instruction. For example, the photographing device 11 performs optical zooming or digital zooming according to the zoom instruction. However, when the user adjusts the focal length of the photographing device 11 through the ground control terminal 14, a size of the target object 41 in the image acquired by the photographing device 11 may be caused to be too large or too small, thereby making it impossible to accurately identify the target object 41 in the image. In response to this problem, the embodiments of the present disclosure provide the control method for the photographing device. The control method for the photographing device will be described below in conjunction with some embodiments.

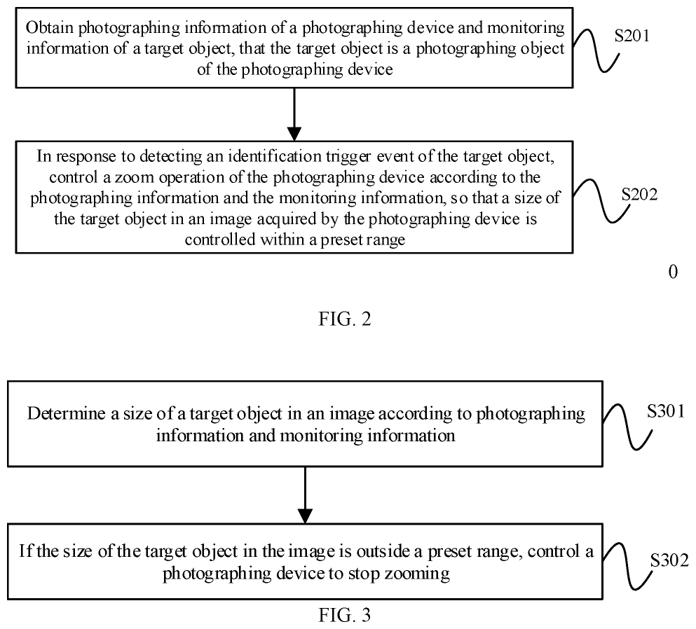

FIG. 2 is a flowchart of a control method for a photographing device according to an example embodiment of the present disclosure. As shown in FIG. 2, the method in some embodiments may include:

Step S201: Obtain photographing information of the photographing device and monitoring information of a target object, that the target object is a photographing object of the photographing device.

As shown in FIG. 1, the photographing device 11 and the processor 15 of the UAV 10 are in a communication connection, and the photographing device 11 can send the image acquired by the photographing device 11 and/or the focal length of the photographing device 11 to the processor 15 in real time. The processor 15 can obtain photographing information of the photographing device 11 and monitoring information of the target object 41 according to the image acquired by the photographing device 11 and/or the focal length of the photographing device 11. The target object 41 is a photographing object of the photographing device 11, such as a human body, a human face, and the like.

In some embodiments, the photographing information includes size information of the image, and the monitoring information includes size information of the target object in the image. For example, the processor 15 can determine the size information of the image according to the image acquired by the photographing device 11, identify the target object 41 in the image to determine position information of the target object 41 in the image, and further determine the size information of the target object 41 in the image according to the position information of the target object 41 in the image. The size information of the image may include a width, height, and/or area of the image, and the size information of the target object 41 in the image may include a width, height, and/or area of the target object 41 in the image.

In some other embodiments, the photographing information includes focal length information of the photographing device, and the monitoring information includes distance information between the target object and the mobile platform or the photographing device. For example, the processor 15 can determine a historical focal length of the photographing device 11 at a certain historical moment according to a focal length sent by the photographing device 11 in real time. The processor 15 can also determine a first distance of the target object 41 relative to the UAV 10 or the photographing device 11 at the historical moment according to a historical image acquired by the photographing device 11 at the historical moment, depth information of the historical image, and internal and external parameters of the photographing device 11 when the historical image is acquired at the historical moment. The processor 15 can also determine a second distance of the target object 41 relative to the UAV 10 or the photographing device 11 at a current moment according to a current image acquired by the photographing device 11 at the current moment, depth information of the current image, and the internal and external parameters of the photographing device 11 at the current moment.

Step S202: In response to detecting a trigger event of identifying the target object, control a zoom operation of the photographing device according to the photographing information and the monitoring information, so that a size of the target object in the image acquired by the photographing device is controlled within a preset range.

For example, when the UAV 10 intelligently follows the target object 41, or when the UAV 10 intelligently follows and photographs the target object 41, it is necessary to identify the target object 41 that is followed. A size of the target object 41 in the image acquired by the photographing device 11 may affect accuracy of identifying the target object 41 by the UAV 10, that is, if the size of the target object 41 in the image acquired by the photographing device 11 is too large or too small, it may cause the UAV 10 to fail to accurately identify the target object 41. Therefore, the size of the target object 41 in the image acquired by the photographing device 11 needs to be controlled within a preset range.

As an achievable manner, the processor 15 of the UAV 10 can detect a trigger event of identifying the target object 41 in real time. For example, the processor 15 can detect a control instruction sent by the ground control terminal 14 to the UAV 10 in real time, and determine whether the target object 41 needs to be identified when executing the control instruction, for example, determine whether the control instruction is a control instruction to control the UAV 10 to intelligently follow the target object 41 or intelligently follow and photograph the target object 41. If the control instruction is the ground control terminal 14 controlling the UAV 10 to intelligently follow or intelligently follow and photograph the target object 41, then the processor 15 can control a zoom operation of the photographing device according to the photographing information of the photographing device and the monitoring information of the target object 41 determined by the above steps, for example, control the photographing device to stop zooming, or control the photographing device to perform zooming, so that the size of the target object 41 in the image acquired by the photographing device 11 is controlled within the preset range.

In some embodiments, by obtaining the photographing information of the photographing device and the monitoring information of the target object, when the trigger event of identifying the target object is detected, the zoom operation of the photographing device is controlled according to the photographing information and the monitoring information, so that the size of the target object in the image acquired by the photographing device is controlled within the preset range to prevent the size of the target object in the image acquired by the photographing device from being too large or too small, so as to improve the accuracy of identifying the target object.

The embodiments of the present disclosure provide a control method for a photographing device. FIG. 3 is a flowchart of a control method for a photographing device according to another example embodiment of the present disclosure. As shown in FIG. 3, on the basis of the embodiments shown in FIG. 2, controlling the zoom operation of the photographing device according to the photographing information and the monitoring information includes: controlling the photographing device to stop zooming according to the photographing information and the monitoring information.

As shown in FIG. 1, 41 represents the target object 41 followed by the UAV 10. When the UAV 10 is flying in an intelligent follow mode, a distance between the UAV 10 and the target object 41 may be fixed. The user can adjust the focal length of the photographing device 11 of the UAV 10 through the ground control terminal 14 to adjust the size of the target object 41 in the image acquired by the photographing device 11. For example, the user adjusts the zoom component on the ground control terminal 14, such as the zoom ring. The ground control terminal 14 generates a zoom instruction according to the user's operation on the zoom ring, and sends the zoom instruction to the UAV 10 through wireless communication. The zoom instruction may include a focal length value. After receiving the zoom instruction, the UAV 10 adjusts current focal length of the photographing device 11 according to the focal length value in the zoom instruction; or, after receiving the zoom instruction, the communication interface 13 of the UAV 10 sends the zoom instruction to the photographing device 11, so that the photographing device 11 adjusts the focal length of a lens according to the zoom instruction, to adjust the size of the target object 41 in the image; or the zoom instruction can be directly sent from the ground control terminal 14 to the photographing device 11, so that the photographing device 11 adjusts the focal length of the lens according to the zoom instruction. The photographing device 11 acquires an image of the target object 41 according to the adjusted focal length and sends the image to the processor 15. The processor 15 can determine the size of the image and the size of the target object 41 in the image, according to the image of the target object 41 acquired by the photographing device 11. If the size of the target object 41 in the image exceeds the preset range, the processor 15 can control the photographing device 11 to stop zooming, so as to prevent the size of the target object 41 in the image from being too large or too small to affect accurate identification of the target object 41 by the processor 15.

In one embodiment, controlling the photographing device to stop zooming according to the photographing information and the monitoring information includes:

Step S301: Determine the size of the target object in the image according to the photographing information and the monitoring information.

In some embodiments, the photographing information includes size information of the image, and the monitoring information includes size information of the target object in the image. After obtaining the image of the target object acquired by the photographing device 11, the processor 15 determines the size information of the image and the size information of the target object in the image, and further according to the size information of the image and the size information of the target object in the image, determines the size of the target object in the image, for example, determines whether the size of the target object in the image is within the preset range, or, determines whether the size of the target object in the image exceeds the preset range.

In one embodiment, determining the size of the target object in the image according to the photographing information and the monitoring information includes: according to the size information of the image and the size information of the target object in the image, determining a size difference between the target object and the image; and if the size difference is greater than a first threshold or the size difference is less than a second threshold, determining that the size of the target object in the image is outside the preset range.

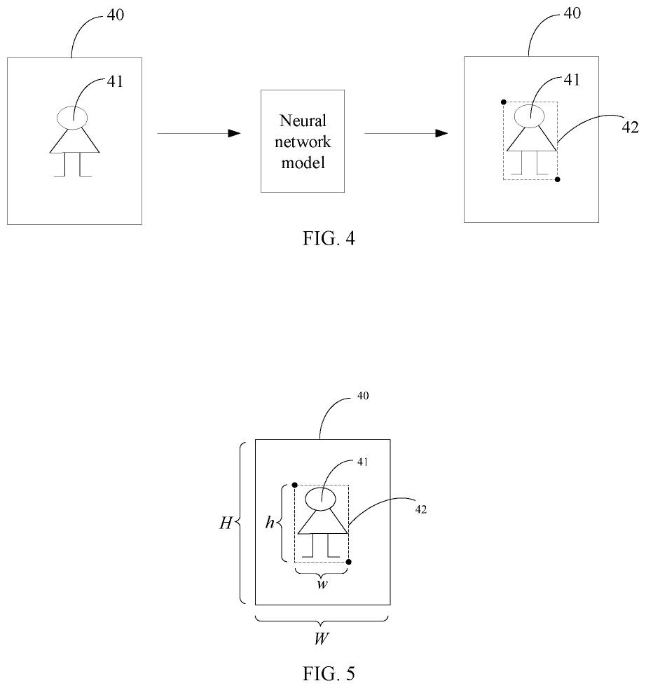

As shown in FIG. 4, 40 represents an image acquired by the photographing device 11. The processor 15 can determine size information of the image 40 and size information of the target object 41 in the image 40 according to the image 40 acquired by the photographing device 11. In some embodiments, the photographing device 11 can also send the size information of the image 40 to the processor 15. One achievable way for the processor 15 to determine the size information of the target object 41 in the image 40 is that: the processor 15 inputs the image 40 into a pre-trained neural network model, that the neural network model may be a model trained in advance through a large number of human samples, and the neural network model can be configured to identify the target object 41 in the image 40, such as a human body. After the target object 41 is identified, a certain position in the target object 41 can be expanded to surroundings according to a preset rule to form a target area 42 including at least a portion of the target object 41. Further, position information of the target object 41 in the image 40 can be output, and the position information may include position information of an upper left corner and a lower right corner of the target area 42 including the target object 41 in the image 40. The size information of the target object 41 in the image 40 may be size information of the target area 42 in the image 40. The processor 15 can determine a size difference between the target object 41 and the image 40 according to the size information of the image 40 and the size information of the target object 41 in the image 40. The size difference may be a ratio of the size of the target object 41 in the image 40 to the size of the image 40, or a difference between the size of the target object 41 in the image 40 and the size of the image 40.

In some embodiments, the size information of the image may include a width and/or height of the image, and the size information of the target object in the image 40 may include a width and/or height of the target area in the image.

As shown in FIG. 5, H represents the height of the image 40. h represents the height of the target area 42 in the image 40, that is, the height of the target object 41 in the image 40. W indicates the width of the image 40. W represents the width of the target area 42 in the image 40, that is, the width of the target object 41 in the image 40.

The size difference between the target object 41 and the image 40 includes a difference between h the height of the target area 42 in the image 40 and H the height of the image 40, and/or a difference between W the width of the target area 42 in the image 40 and W the width of the image 40.

In some embodiments, the difference between h the height of the target area 42 in the image 40 and H the height of the image 40 is a ratio of h to H, and the difference between W the width of the target area 42 in the image 40 and W the width of the image 40 is a ratio of w to W. In this case, determining that the size of the target object 41 in the image 40 is outside the preset range may include the following possible implementation manners:

In one embodiment: if the ratio of h the height of the target area 42 in the image 40 to H the height of the image 40 is greater than a first threshold ε₁, that is, h and H satisfy a condition described in the following formula (1), or the ratio of h the height of the target area 42 in the image 40 to H the height of the image 40 is less than a second threshold ε₂, that is, h and H satisfy a condition described in the following formula (2), where the first threshold ε₁ is greater than the second threshold ε₂, then it is determined that the size of the target object 41 in the image 40 is outside the preset range.

$$\begin{matrix}\frac{h}{H} > {ɛ}_{1} & ( 1 ) \\ \frac{h}{H} < {ɛ}_{2} & ( 2 )\end{matrix}$$

In another embodiment: if the ratio of w the width of the target area 42 in the image 40 to W the width of the image 40 is greater than the first threshold ε₁, that is, w and W satisfy a condition described in the following formula (3), or the ratio of w the width of the target area 42 in the image 40 to W the width of the image 40 is smaller than the second threshold ε₂, that is, w and W satisfy a condition described in the following formula (4), where the first threshold ε₁ is greater than the second threshold ε₂, then it is determined that the size of the target object 41 in the image 40 is outside the preset range.

$$\begin{matrix}\frac{w}{W} > {ɛ}_{1} & ( 3 ) \\ \frac{w}{W} < {ɛ}_{2} & ( 4 )\end{matrix}$$

In another embodiment: if the ratio of h the height of the target area 42 in the image 40 to H the height of the image 40 is greater than the first threshold ε₁, and the ratio of w the width of the target area 42 in the image 40 to W the width of the image 40 is greater than the first threshold ε₁; or the ratio of h the height of the target area 42 in the image 40 to H the height of the image 40 is less than the second threshold ε₂, and the ratio of w the width of the target area 42 in the image 40 to W the width of the image 40 is less than the second threshold ε₂, where the first threshold ε₁ is greater than the second threshold ε₂, then it is determined that the size of the target object 41 in the image 40 is outside the preset range.

In other embodiments, the difference between h the height of the target area 42 in the image 40 and H the height of the image 40 is an absolute value of the difference between h and H, and the difference between w the width of the target area 42 in the image 40 and W the width of the image 40 is an absolute value of the difference between w and W. In this case, determining that the size of the target object 41 in the image 40 is outside the preset range may include the following possible implementation manners:

In one embodiment: if the absolute value of the difference between h the height of the target area 42 in the image 40 and H the height of the image 40 is greater than a first threshold, or the absolute value of the difference between h the height of the target area 42 in the image 40 and H the height of the image 40 is smaller than a second threshold, where the first threshold is greater than the second threshold, then it is determined that the size of the target object 41 in the image 40 is outside the preset range.

In another embodiment: if the absolute value of the difference between w the width of the target area 42 in the image 40 and W the width of the image 40 is greater than the first threshold, or the absolute value of the difference between w the width of the target area 42 in the image 40 and W the width of the image 40 is smaller than the second threshold, where the first threshold is greater than the second threshold, then it is determined that the size of the target object 41 in the image 40 is outside the preset range.

In another embodiment: if the absolute value of the difference between h the height of the target area 42 in the image 40 and H the height of the image 40 is greater than the first threshold, and the absolute value of the difference between w the width of the target area 42 in the image 40 and W the width of the image 40 is greater than the first threshold; or, the absolute value of the difference between h the height of the target area 42 in the image 40 and H the height of the image 40 is less than the second threshold, and the absolute value of the difference between w the width of the target area 42 in the image 40 and W the width of the image 40 is smaller than the second threshold, where the first threshold is greater than the second threshold, then it is determined that the size of the target object 41 in the image 40 is outside the preset range.

In some other embodiments, the monitoring information includes size information of the target object in a selected area of the image, and at least a portion of the target object is located in the selected area.

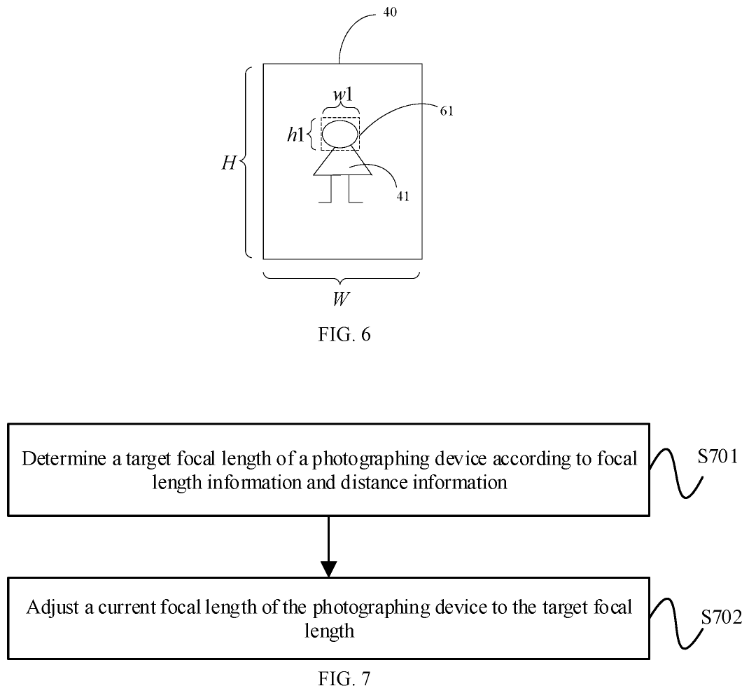

As shown in FIG. 6, 40 represents the image acquired by the photographing device 11. The processor 15 can send the image 40 to the ground control terminal 14 through the communication interface 13, and the ground control terminal 14 displays the image 40 in a display component. The display component may be a touch screen. The user can select the target object 41 in the image 40 on the touch screen (e.g., using a frame). For example, the user can select the entire target object 41 on the touch screen, or select a portion of the target object 41. Taking the user selecting a portion of the target object 41 as an example, as shown in FIG. 6, 61 represents a selected area (e.g., a frame-selected area) of the target object 41 in the image 40, and at least a portion of the target object 41 is located in the selected area, for example, the target object 41 is a human body, and the user selects a human face of the human body, that is, the human face is located in the selected area. The ground control terminal 14 further sends position information of the selected area 61 in the image 40 to the UAV 10. After obtaining the position information of the selected area 61 in the image 40, the processor 15 determines a size of the selected area 61 in the image 40, and uses the size of the selected area 61 in the image 40 as the monitoring information of the target object 41. The size of the selected area 61 in the image 40 may include a height and/or width of the selected area 61 in the image 40. As shown in FIG. 6, w1 represents the width of the selected area 61, and h1 represents the height of the selected area 61.

It can be understood that after the user performs a frame selection operation on the ground control terminal 14, size information of the selected area 61 may not be determined based on the position information in the image 40 sent by the ground control terminal 14, and other methods may also be used. For example, the ground control terminal 14 calculates the size information of the selected area 61 and sends the size information to the UAV 10, and the methods are not limited here.

It should be noted that, in the embodiments shown in FIG. 6, the selected area 61 may also be obtained after the user clicks on the touch screen or obtained through other interaction methods with the ground control terminal 14. In addition, an original size of the image 40 displayed in the display component may be scaled in proportion to a display size of the display component, or may be scaled disproportionately. When using the size information of the image 40, the proportionately scaled size information may be used, and the disproportionately scaled information may also be used, which can be set according to needs.

In one embodiment, the selected area is a rectangular area; and the size difference includes a difference between the width of the selected area and the width of the image, and/or a difference between the height of the selected area and the width of the image. As shown in FIG. 6, the selected area 61 is a rectangular area, and size difference between the target object 41 and the image 40 may be a difference between the width of the selected area 61 and the width of the image 40, and/or a difference between the height of the selected area 61 and the height of the image 40.

In some embodiments, the difference between the width of the selected area 61 and the width of the image 40 may be a ratio of w1 the width of the selected area 61 to W the width of the image 40, and the difference between the height of the selected area 61 and the height of the image 40 may be a ratio of h1 the height of the selected area 61 to H the height of the image 40. In this case, determining that the size of the target object 41 in the image 40 is outside the preset range may include the following possible implementation manners:

In one embodiment: if the ratio of w1 the width of the selected area 61 to W the width of the image 40 is greater than the first threshold &ⱼ, or the ratio of w1 the width of the selected area 61 to W the width of the image 40 is less than the second threshold ε₂, where the first threshold ε₁ is greater than the second threshold ε₂, then it is determined that the size of the target object 41 in the image 40 is outside the preset range.

In another embodiment: if the ratio of h1 the height of the selected area 61 to H the height of the image 40 is greater than the first threshold ε₁, or the ratio of h1 the height of the selected area 61 to H the height of the image 40 is less than the second threshold ε₂, where the first threshold ε₁ is greater than the second threshold ε₂, then it is determined that the size of the target object 41 in the image 40 is outside the preset range.

In another embodiment: if the ratio of w1 the width of the selected area 61 to W the width of the image 40 is greater than the first threshold ε₁ and the ratio of h1 the height of the selected area 61 to H the height of the image 40 is greater than the first threshold ε₁; or, the ratio of w1 the width of the selected area 61 to W the width of the image 40 is less than the second threshold ε₂, and the ratio of h1 the height of the selected area 61 to H the height of the image 40 is less than the second threshold ε₂, where the first threshold ε₁ is greater than the second threshold ε₂, then it is determined that the size of the target object 41 in the image 40 is outside the preset range.

In other embodiments, the difference between the width of the selected area 61 and the width of the image 40 may be an absolute value of the difference between the width of the selected area 61 and the width of the image 40, and the difference between the height of the selected area 61 and the height of the image 40 may be an absolute value of the difference between the height of the selected area 61 and the height of the image 40. In this case, determining that the size of the target object 41 in the image 40 is outside the preset range may include the following possible implementation manners:

In one embodiment: if the absolute value of the difference between w1 the width of the selected area 61 and W the width of the image 40 is greater than a first threshold, or the absolute value of the difference between w1 the width of the selected area 61 and W the width of the image 40 is less than a second threshold, where the first threshold is greater than the second threshold, then it is determined that the size of the target object 41 in the image 40 is outside the preset range.

In another embodiment: if the absolute value of the difference between h1 the height of the selected area 61 and H the height of the image 40 is greater than the first threshold, or the absolute value of the difference between h1 the height of the selected area 61 and H the height of the image 40 is less than the second threshold, where the first threshold is greater than the second threshold, then it is determined that the size of the target object 41 in the image 40 is outside the preset range.

In another embodiment: if the absolute value of the difference between w1 the width of the selected area 61 and W the width of the image 40 is greater than the first threshold, and the absolute value of the difference between h1 the height of the selected area 61 and H the height of the image 40 is greater than the first threshold; or, the absolute value of the difference between w1 the width of the selected area 61 and W the width of the image 40 is less than the second threshold, and the absolute value of the difference between h1 the height of the selected area 61 and H the height of the image 40 is less than the second threshold, where the first threshold is greater than the second threshold, then it is determined that the size of the target object 41 in the image 40 is outside the preset range.

In some other embodiments, the photographing information includes area information of the image, and the monitoring information includes area information of the target object in the image. After obtaining the image of the target object acquired by the photographing device 11, the processor 15 determines the area information of the image and the area information of the target object in the image, and further, according to the area information of the image and the area information of the target object in the image, determines the size of the target object in the image, for example, determines whether the size of the target object in the image is within the preset range, or, determine whether the size of the target object in the image exceeds the preset range.

In one embodiment, determining the size of the target object in the image according to the photographing information and the monitoring information includes: according to the area information of the image and the area information of the target object in the image, determining an area difference between the target object and the image; and if the area difference is greater than a third threshold or the area difference is less than a fourth threshold, determining that the size of the target object in the image is outside the preset range.

As shown in FIG. 5, an area of the image 40 is a product of H the height of the image 40 and W the width of the image 40, and an area of the target object 41 in the image 40 is a product of h the height of the target area 42 in the image 40 including the target object 41 and W the width of the target area 42 in the image 40 including the target object 41. An area difference between the target object 41 and the image 40 may be a ratio of the area of the target object 41 in the image 40 to the area of the image 40, or the area difference is an absolute value of a difference between the area of the target object 41 in the image 40 and the area of the image 40. In this case, determining that the size of the target object 41 in the image 40 is outside the preset range may include the following possible implementation manners:

In one embodiment: if the ratio of the area of the target object 41 in the image 40 to the area of the image 40 is greater than a third threshold, or the ratio of the area of the target object 41 in the image 40 to the area of the image 40 is less than a fourth threshold, where the third threshold is greater than the fourth threshold, than it is determined that the size of the target object 41 in the image 40 is outside the preset range.

In another embodiment: if the absolute value of the difference between the area of the target object 41 in the image 40 and the area of the image 40 is greater than a third threshold, or the absolute value of the difference between the area of the target object 41 in the image 40 and the area of the image 40 is less than a fourth threshold, where the third threshold is greater than the fourth threshold, then it is determined that the size of the target object 41 in the image 40 is outside the preset range.

In some other embodiments, the monitoring information includes area information of a selected area of the target object in the image, and at least a portion of the target object is located in the selected area.

As shown in FIG. 6, 61 represents the selected area of the target object 41 in the image 40, and at least a portion of the target object 41 is located in the selected area. The processor 15 may also use an area of the selected area 61 in the image 40 as the monitoring information of the target object 41. The area of the selected area 61 in the image 40 is a product of h1 the height of the selected area 61 and w1 the width of the selected area 61. In this case, determining that the size of the target object 41 in the image 40 is outside the preset range may include the following possible implementation manners:

In one embodiment: if a ratio of the area of the selected area 61 in the image 40 to the area of the image 40 is greater than a third threshold, or the ratio of the area of the selected area 61 in the image 40 to the area of the image 40 is smaller than a fourth threshold, where the third threshold is greater than the fourth threshold, then it is determined that the size of the target object 41 in the image 40 is outside the preset range.

In another embodiment: if an absolute value of a difference between the area of the selected area 61 in the image 40 and the area of the image 40 is greater than a third threshold, or the absolute value of the difference between the area of the selected area 61 in the image 40 and the area of the image 40 is less than a fourth threshold, where the third threshold is greater than the fourth threshold, then it is determined that the size of the target object 41 in the image 40 is outside the preset range.

Step S302: If the size of the target object in the image is outside the preset range, control the photographing device to stop zooming.

According to any one of the above steps, if it is determined that the size of the target object 41 in the image 40 is outside the preset range, the photographing device 11 of the UAV 10 is controlled to stop zooming.

For example, when the user increases the focal length of the photographing device 11 through the ground control terminal 14, the size of the target area 42 in the image 40 gradually increases. If the ratio of the height of the target area 42 in the image 40 to the height of the image 40 is greater than the first threshold, and/or the ratio of the width of the target area 42 in the image 40 to the width of the image 40 is greater than the first threshold, then it is determined that the size of the target object 41 in the image 40 is outside the preset range. At this time, it is necessary to control the photographing device 11 to stop zooming to prevent the size of the target area 42 in the image 40 from further increasing. Similarly, when the user reduces the focal length of the photographing device 11 through the ground control terminal 14, the size of the target area 42 in the image 40 gradually decreases. If the ratio of the height of the target area 42 in the image 40 to the height of the image 40 is less than the second threshold, and/or the ratio of the width of the target area 42 in the image 40 to the width of the image 40 is less than the second threshold, then it is determined that the size of the target object 41 in the image 40 is outside of the preset range. At this time, it is necessary to control the photographing device 11 to stop zooming to prevent the size of the target area 42 in the image 40 from being further reduced.

In some embodiments, controlling the photographing device to stop zooming includes: controlling the photographing device to stop executing a zoom instruction received by the photographing device, that the zoom instruction is configured to adjust the focal length of the photographing device.

For example, the ground control terminal 14 sends a zoom instruction to the UAV 10 through wireless communication. The zoom instruction may include a focal length value. After obtaining the zoom instruction, the processor 15 of the UAV 10 will use the focal length value in the zoom instruction to adjust current focal length of the photographing device 11; or the communication interface 13 of the UAV 10 receives the zoom instruction and sends the zoom instruction to the photographing device 11 so that the photographing device 11 can adjust the focal length of the lens according to the zoom instruction; or the zoom instruction may be directly sent from the ground control terminal 14 to the photographing device 11, so that the photographing device 11 adjusts the focal length of the lens according to the zoom instruction. The photographing device 11 acquires the image of the target object 41 according to the adjusted focal length and sends the image to the processor 15. If determining that the size of the target object 41 in the image 40 is outside the preset range, the processor 15 controls the photographing device 11 to stop executing the zoom instruction received by the photographing device 11. For example, the processor 15 of the UAV 10 sends a stop zooming instruction to the photographing device 11 through the communication interface 13, so that the photographing device 11 stops executing the received zoom instruction according to the stop zooming instruction.

In some other embodiments, after controlling the photographing device to stop zooming, the method further includes: sending stop zooming prompt information to a control terminal, so that the control terminal prompts the user according to the stop zooming prompt information, and the control terminal is configured to control the mobile platform (e.g., control a movement of the mobile platform). To improve user experience, after controlling the photographing device 11 to stop executing the zoom instruction, the processor 15 can also send stop zooming prompt information to the ground control terminal 14. The stop zooming prompt information can be configured to prompt that the size of the target object in the image 40 is too large or too small, so that the ground control terminal 14 prompts the user according to the stop zooming prompt information, and the user can stop adjusting the zoom component on the ground control terminal 14, such as the zoom ring, according to the prompt of the ground control terminal 14.

In some embodiments, the size of the target object in the image is determined by the photographing information of the photographing device and the monitoring information of the target object. If the size of the target object in the image is outside the preset range, the photographing device is controlled to stop zooming to prevent the size of the target object in the image acquired by the photographing device from being too large or too small when the user adjusts the focal length of the photographing device through the ground control terminal, so that the size of the target object in the image acquired by the photographing device is controlled within the preset range to improve the accuracy of identifying the target object.

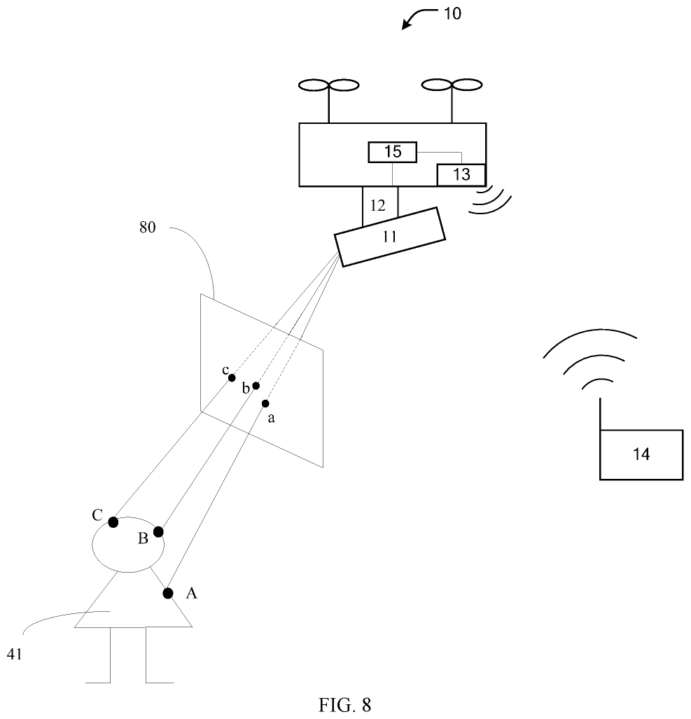

The embodiments of the present disclosure provide a control method for a photographing device. FIG. 7 is a flowchart of a control method for a photographing device according to another example embodiment of the present disclosure. As shown in FIG. 7, on the basis of the foregoing embodiments, controlling the zoom operation of the photographing device according to the photographing information and the monitoring information includes: controlling the photographing device to perform zooming according to the photographing information and the monitoring information.

As shown in FIG. 8, when the photographing device 11 of the UAV 10 intelligently follows and photographs the target object 41, the UAV 10 and/or the target object 41 may move, resulting in a change of the distance between the UAV 10 and the target object 41, or a change of the distance between the photographing device 11 and the target object 41, which causes the size of the target object 41 in the image acquired by the photographing device 11 to change. If the size of the target object 41 in the image acquired by the photographing device 11 is too large or too small, it can affect the accurate identification of the target object 41 by the processor 15 of the UAV 10. If the processor 15 cannot accurately identify the target object 41 in the image, the processor 15 cannot be able to accurately determine the position information and/or speed information of the target object 41, and thus cannot control the photographing device 11 to intelligently follow and photograph the target object 41. To solve this problem, in some embodiments, the photographing device 11 can be controlled to perform zooming according to the photographing information of the photographing device 11 and the monitoring information of the target object 41. In one embodiment, the photographing information includes focal length information of the photographing device, and the monitoring information includes distance information between the target object and the mobile platform or the photographing device. That is, according to the focal length information of the photographing device 11 and the distance information between the target object 41 and the UAV 10 or the photographing device 11, the photographing device 11 can be controlled to perform zooming, for example, the photographing device 11 can be controlled to adjust the focal length.

As shown in FIG. 8, the photographing device 11 can send the focal length of the photographing device 11 and the image acquired by the photographing device 11 to the processor 15 in real time, and the processor 15 can determine the focal length of the photographing device 11 at different moments, according to the focal length sent by the photographing device 11 in real time. In addition, the processor 15 can also determine the position information of the target object 41 at different moments according to images acquired by the photographing device 11 at different moments. The position information of the target object 41 may be three-dimensional coordinates of the target object 41 in a world coordinate system. As shown in FIG. 8, 80 represents an image acquired by the photographing device 11 at a certain moment. It can be understood that a three-dimensional point on the target object 41 can be mapped to the image 80, and a mapping point of the three-dimensional point in the image 80 may be a feature point in the image 80. For example, point A, point B, and point C, are three-dimensional points on the target object 41, and point a, point b, and point c, respectively represent feature points in the image 80. The point a is a mapping point of the point A in the image 80, the point b is a mapping point of the point B in the image 80, and the point c is a mapping point of the point C in the image 80. This is only a schematic description, and does not limit the mapping points of the three-dimensional points on the target object 41 in the image 80. According to a conversion relationship between the world coordinate system and a pixel plane coordinate system, a relationship between three-dimensional coordinates (x_{w},y_{w},z_{w}) of a three-dimensional point on the target object 41 in the world coordinate system and position information, such as pixel coordinates (μ,ν), in the image 80 of a mapping point of the three-dimensional point in the image 80 can be obtained. The relationship is shown in the following formula (5):

$${z}_{c} [ \begin{matrix}μ \\ υ \\ 1\end{matrix} ] = K [ R \vert T ] [ \begin{matrix}{x}_{w} \\ {y}_{w} \\ {z}_{w} \\ 1\end{matrix} ] , \qquad ( 5 )$$

where, z_{c} represents a coordinate of the three-dimensional point on a Z axis of a photographing device coordinate system, that is, a depth information of the image 80; K represents internal parameters of the photographing device; R represents a rotation matrix of the photographing device; and T represents a translation matrix of the photographing device. According to (ν,ν), K, R, T, and z_{c}, the three-dimensional coordinates (x_{w},y_{w},z_{w}) of the three-dimensional point in the world coordinate system can be calculated. In some embodiments, the three-dimensional coordinates of the three-dimensional point A in the world coordinate system can be calculated according to the pixel coordinates, K, R, T, and z_{c}, of the point a in the image 80. According to the pixel coordinates, K, R, T, and z_{c}, of the point b in the image 80, the three-dimensional coordinates of the three-dimensional point B in the world coordinate system can be calculated. According to the pixel coordinates, K, R, T, and z_{c}, of the point c in the image 80, the three-dimensional coordinates of the three-dimensional point C in the world coordinate system can be calculated. Further, according to the three-dimensional coordinates of the three-dimensional points A, B, and C in the world coordinate system, the three-dimensional coordinates of the target object 41 in the world coordinate system can be calculated.

According to the above formula (5), the processor 15 can determine the three-dimensional coordinates of the target object 41 in the world coordinate system at a certain moment according to the image 80 acquired by the photographing device 11 at the certain moment. Further, according to the three-dimensional coordinates of the target object 41 in the world coordinate system at the certain moment and the position information of the UAV 10 at the certain moment, a distance of the target object 41 relative to the UAV 10 at the certain moment can be determined. In some embodiments, the processor 15 can determine a distance of the target object 41 relative to the photographing device 11 at the certain moment, according to the three-dimensional coordinates of the target object 41 in the world coordinate system at the certain moment, the position information of the UAV 10 at the certain moment, and position and attitude of the photographing device 11 relative to the vehicle body of the UAV 10.

In one embodiment, according to the photographing information and the monitoring information, controlling the photographing device to perform zooming, so that the size of the target object in the image acquired by the photographing device is controlled within the preset range, includes: controlling the photographing device to perform zooming according to the photographing information and the monitoring information, so as to maintain the size of the target object in the image acquired by the photographing device.

For example, when the distance between the UAV 10 or the photographing device 11 relative to the target object 41 increases, the size of the target object 41 in the image acquired by the photographing device 11 may become smaller. At this time, the photographing device 11 can be controlled to perform zooming, for example, increasing the focal length of the photographing device 11, so that the size of the target object 41 in the image acquired by the photographing device 11 remains unchanged or remains within the preset range. When the distance between the UAV 10 or the photographing device 11 relative to the target object 41 decreases, the size of the target object 41 in the image acquired by the photographing device 11 may become larger. At this time, the photographing device 11 can be controlled to perform zooming, for example, reducing the focal length of the photographing device 11, so that the size of the target object 41 in the image acquired by the photographing device 11 remains unchanged or remains within the preset range.

In some embodiments, controlling the photographing device to perform zooming according to the photographing information and the monitoring information includes:

Step S701: Determine a target focal length of the photographing device according to the focal length information and the distance information.

The focal length information includes a historical focal length of the photographing device at a historical moment; and the distance information includes a first distance of the target object relative to the mobile platform or the photographing device at the historical moment, and a second distance of the target object relative to the mobile platform or the photographing device at a current moment.

For example, the processor 15 can determine a historical focal length of the photographing device 11 at a historical moment according to the focal length sent by the photographing device 11 in real time. The processor 15 can determine the three-dimensional coordinates of the target object 41 in the world coordinate system at the historical moment according to an image acquired by the photographing device 11 at the historical moment, and further determine a distance of the target object 41 relative to the UAV 10 or the photographing device 11 at the historical moment, here, the distance of the target object 41 relative to the UAV 10 or the photographing device 11 at the historical moment is recorded as a first distance. In addition, the processor 15 can also determine the three-dimensional coordinates of the target object 41 in the world coordinate system at a current moment according to an image acquired by the photographing device 11 at the current moment, and further, determine a distance of the target object 41 relative to the UAV 10 or the photographing device 11 at the current moment, here, the distance of the target object 41 relative to the UAV 10 or the photographing device 11 at the current moment is recorded as a second distance. Further, according to the historical focal length of the photographing device 11 at the historical moment, the first distance of the target object 41 relative to the UAV 10 or the photographing device 11 at the historical moment, and the second distance of the target object 41 relative to the UAV 10 or the photographing device 11 at the current moment, a target focal length of the photographing device 11 is determined, and the so-called target focal length refers to adjusting the current focal length of the photographing device 11 to the target focal length.

Determining the target focal length of the photographing device according to the focal length information and the distance information includes: determining the target focal length of the photographing device according to the historical focal length, the first distance, and the second distance.

For example, the historical focal length of the photographing device 11 at the historical moment is recorded as fᵢₙᵢₜ, the first distance of the target object 41 relative to the UAV 10 or the photographing device 11 at the historical moment is recorded as dᵢₙᵢₜ, and the second distance of the target object 41 relative to the UAV 10 or the photographing device 11 at the current moment is recorded as d_{cur}, the target focal length f_{cmd} of the photographing device 11 can be calculated according to the following formula (6):

$${f}_{cmd} = \frac{{f}_{init} {d}_{c u r}}{{d}_{init}} \qquad ( 6 )$$

In some embodiments, the historical moment is a moment when the mobile platform starts to follow the target object. As shown in FIG. 1, the processor 15 may be the flight controller of the UAV 10, and the flight controller can control the UAV 10 to intelligently follow the target object 41. In some embodiments, the ground control terminal 14 sends an intelligent follow control instruction to the UAV 10, and when obtaining the intelligent follow control instruction, the flight controller determines the distance of the target object 41 relative to the UAV 10 or the photographing device 11. When the distance is less than a preset distance, the flight controller sends a prompt message to the ground control terminal 14, so that the ground control terminal 14 prompts the user that the target object 41 is too close to the UAV 10 or the photographing device 11, and the target object 41 cannot be intelligently followed. The user can control the distance between the target object 41 and the UAV 10 or the photographing device 11 to increase through the ground control terminal 14 according to the prompt message. When the distance is adjusted to be greater than the preset distance, the flight controller starts to control the UAV 10 to intelligently follow the target object 41. In one embodiment, at the historical moment when the UAV 10 starts to follow the target object 41, the size of the target object 41 in the image acquired by the photographing device 11 is within the preset range. According to the real-time focal length sent by the photographing device 11 to the flight controller, the flight controller determines that the historical focal length of the photographing device 11 is fᵢₙᵢₜ at the historical moment when the UAV 10 starts to follow the target object 41. The flight controller can also determine the first distance dᵢₙᵢₜ of the target object 41 relative to the UAV 10 or the photographing device 11 at the historical moment according to the historical moment when the UAV 10 starts to follow the target object 41 and the image acquired by the photographing device 11. In addition, the flight controller can also determine the second distance d_{cur} of the target object 41 relative to the UAV 10 or the photographing device 11 at the current moment according to the image of the target object 41 acquired by the photographing device 11 at the current moment. Further, the target focal length f_{cmd} of the photographing device 11 is calculated according to the above formula (6).

In other embodiments, the historical moment is a moment when the size of the target object in the image is within the preset range. For example, in a process of intelligently following the target object 41 by the UAV 10, the ground control terminal 14 may send a zoom instruction to the photographing device 11 to adjust the focal length of the photographing device 11, thereby adjusting the size of the target object 41 in the image acquired by the photographing device 11. The processor 15 of the UAV 10 can record the historical moment when the size of the target object 41 in the image is within the preset range, and according to the historical focal length fᵢₙᵢₜ of the photographing device 11 at the historical moment, the first distance dᵢₙᵢₜ, of the target object 41 relative to the UAV 10 or the photographing device 11 at the historical moment, and the second distance d_{cur} of the target object 41 relative to the UAV 10 or the photographing device 11 at the current moment, calculate the target focal length f_{cmd} of the photographing device 11 according to the above formula (6).

In some other embodiments, the method further includes: during a photographing process of the photographing device, if a user's zoom instruction is received, adjusting the current focal length of the photographing device according to the zoom instruction, and setting the adjusted current focal length as the historical focal length.

For example, in a process of photographing the target object 41 by the photographing device 11, the photographing device 11 may send an acquired image to the ground control terminal 14, and the ground control terminal 14 displays the image in the display component. If the target object 41 in the display component is not within the preset range, the user can send a zoom instruction to the UAV 10 through the ground control terminal 14. After obtaining the zoom instruction, the processor 15 of the UAV 10 will adjust the current focal length of the photographing device 11 according to the zoom instruction. For example, the processor 15 obtains a zoom instruction at time t1, and adjusts the current focal length of the photographing device 11 at time t1 according to the zoom instruction. The first distance of the target object 41 relative to the UAV 10 or the photographing device 11 at time t1 is dᵢₙᵢₜ. After time t1, the distance between the target object 41 and the UAV 10 or the photographing device 11 may change. For example, the second distance of the target object 41 relative to the UAV 10 or the photographing device 11 at a current time t2 is d_{cur}, then, the current focal length adjusted by the photographing device 11 at time t1 can be used as the historical focal length, and further, the target focal length of the photographing device 11 can be calculated according to the above formula (6).

Step S702: Adjust the current focal length of the photographing device to the target focal length.

After calculating the target focal length f_{cmd} of the photographing device 11 through the above steps, the processor 15 of the UAV 10 can send the target focal length f_{cmd} to the photographing device 11, and the photographing device 11 adjusts its current focal length to the target focal length f_{cmd}, or the processor 15 can directly adjust the current focal length of the photographing device 11 to be the target focal length f_{cmd} according to the target focal length f_{cmd}.

In some embodiments, by using the focal length information of the photographing device and the distance information between the target object and the UAV or the photographing device, the photographing device is controlled to perform zooming to maintain the size of the target object in the image acquired by the photographing device. The size of the target object in the image acquired by the photographing device is controlled within the preset range, so as to improve the accuracy of identifying the target object.

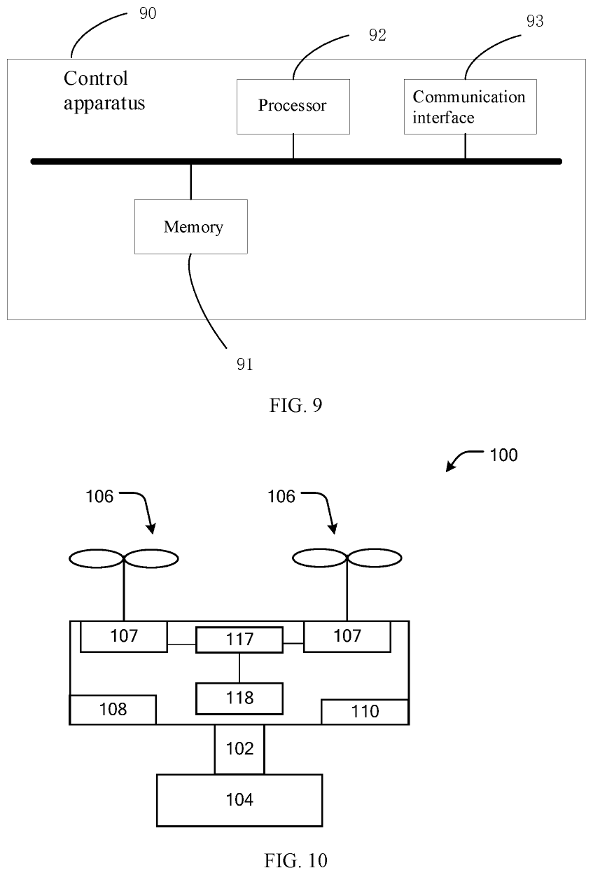

The embodiments of the present disclosure provide a control apparatus for a photographing device. FIG. 9 is a structural diagram of a control apparatus for a photographing device according to an example embodiment of the present disclosure. As shown in FIG. 9, a control apparatus 90 for a photographing device includes: a memory 91 and a processor 92. The memory 91 is configured to store program codes, and the processor 92 calls the program codes. When the program codes are executed, the processor 92 is configured to perform the following operations: obtaining photographing information of the photographing device and monitoring information of a target object, that the target object is a photographing object of the photographing device; and in response to detecting a trigger event of identifying the target object, controlling a zoom operation of the photographing device according to the photographing information and the monitoring information, so that a size of the target object in an image acquired by the photographing device is controlled within a preset range.

In one embodiment, when the processor 92 controls the zoom operation of the photographing device according to the photographing information and the monitoring information, the processor 92 may be configured to: control the photographing device to stop zooming according to the photographing information and the monitoring information.

In one embodiment, when the processor 92 controls the photographing device to stop zooming according to the photographing information and the monitoring information, the processor 92 may be configured to: according to the photographing information and the monitoring information, determine a size of the target object in the image; and if the size of the target object in the image is outside the preset range, control the photographing device to stop zooming.

In one embodiment, the photographing information includes size information of the image, and the monitoring information includes size information of the target object in the image. When the processor 92 determines the size of the target object according to the photographing information and the monitoring information, the processor 92 may be configured to: determine a size difference between the target object and the image according to the size information of the image and the size information of the target object in the image; and if the size difference is greater than a first threshold or the size difference is less than a second threshold, determine that the size of the target object in the image is outside the preset range and control the photographing device to stop zooming.

In one embodiment, the monitoring information includes size information of a selected area of the target object in the image, and at least a portion of the target object is located in the selected area.

In one embodiment, the selected area is a rectangular area; and the size difference includes a difference between a width of the selected area and a width of the image, and/or a difference between a height of the selected area and a height of the image.

In one embodiment, the photographing information includes area information of the image, and the monitoring information includes area information of the target object in the image. When the processor 92 determines the size of the target object according to the photographing information and the monitoring information, the processor 92 may be configured to: determine an area difference between the target object and the image according to the area information of the image and the area information of the target object in the image; and if the area difference is greater than a third threshold or the area difference is less than a fourth threshold, determine that the size of the target object in the image is outside the preset range.

In one embodiment, the monitoring information includes area information of a selected area of the target object in the image, and at least a portion of the target object is located in the selected area.

In one embodiment, when the processor 92 controls the photographing device to stop zooming, the processor 92 may be configured to: control the photographing device to stop executing a zoom instruction received by the photographing device, that the zoom instruction is configured to adjust the focal length of the photographing device.

In one embodiment, the control apparatus 90 further includes: a communication interface 93. After the processor 92 controls the photographing device to stop zooming, it is further configured to: send stop zooming prompt information to a control terminal through the communication interface 93, so that the control terminal prompts to a user according to the stop zooming prompt information, that the control terminal is configured to control a mobile platform.

In one embodiment, when the processor 92 controls the zoom operation of the photographing device according to the photographing information and the monitoring information, the processor 92 may be configured to: control the photographing device to perform zooming according to the photographing information and the monitoring information.

In one embodiment, when the processor 92 controls the photographing device to perform zooming according to the photographing information and the monitoring information, so that the size of the target object in the image acquired by the photographing device is controlled within the preset range, the processor 92 may be configured to: control the photographing device to perform zooming according to the photographing information and the monitoring information, so as to maintain the size of the target object in the image acquired by the photographing device.

In one embodiment, the photographing information includes focal length information of the photographing device, and the monitoring information includes distance information between the target object and the mobile platform or the photographing device. When the processor 92 controls the photographing device to perform zooming according to the photographing information and the monitoring information, the processor 92 may be configured to: determine a target focal length of the photographing device according to the focal length information and the distance information; and control the current focal length of the photographing device to be the target focal length.

In one embodiment, the focal length information includes a historical focal length of the photographing device at a historical moment; and the distance information includes a first distance of the target object relative to the mobile platform or the photographing device at the historical moment, and a second distance of the target object relative to the mobile platform or the photographing device at a current moment. When the processor 92 determines the target focal length of the photographing device according to the focal length information and the distance information, the processor 92 may be configured to: determine the target focal length of the photographing device according to the historical focal length, the first distance, and the second distance.

In one embodiment, the historical moment is a moment when the mobile platform starts to follow the target object.

In one embodiment, the historical moment is a moment when the size of the target object in the image is within the preset range.

In one embodiment, the control apparatus 90 further includes the communication interface 93. The processor 92 is further configured to: during a photographing process of the photographing device, if a user's zoom instruction is received through the communication interface 93, adjust current focal length of the photographing device according to the zoom instruction, and use the adjusted current focal length as the historical focal length.

The detailed principles and implementation manners of the control apparatus provided by the embodiments of the present disclosure are similar to the foregoing embodiments, and will not be repeated here.

In some embodiments, by obtaining the photographing information of the photographing device and the monitoring information of the target object, when the trigger event of identifying the target object is detected, the zoom operation of the photographing device is controlled according to the photographing information and the monitoring information, so that the size of the target object in the image acquired by the photographing device is controlled within the preset range to prevent the size of the target object in the image acquired by the photographing device from being too large or too small, so as to improve the accuracy of identifying the target object.

The embodiments of the present disclosure provide a mobile platform. The mobile platform includes at least one of the following: a UAV, a mobile robot, or a handheld gimbal. Taking a UAV as an example, FIG. 10 is a structural diagram of a UAV according to an example embodiment of the present disclosure. As shown in FIG. 10, a UAV 100 includes a vehicle body, a propulsion system, a photographing device 104, and a control apparatus 118. The propulsion system includes at least one of the following: motors 107, propellers 106, and an electronic speed control (ESC) 117. The propulsion system is installed on the vehicle body to provide flight power (e.g., propulsion). The photographing device 104 is configured to acquire images. The detailed principles of the control apparatus 118 and the implementation manners are consistent with the control apparatus described in the foregoing embodiments, and will not be repeated here. In some embodiments, the control apparatus 118 may include a flight controller.

In addition, as shown in FIG. 10, the UAV 100 further includes: a sensing system 108, a communication system 110, a supporting device 102, and the photographing device 104. The supporting device 102 may be a gimbal. The communication system 110 may include a receiver, and the receiver is configured to receive wireless signals sent by a ground control terminal.

In addition, the embodiments also provide a computer-readable storage medium on which a computer program is stored, and the computer program is executed by a processor to implement the control method for the photographing device described in the foregoing embodiments.

In the embodiments provided by the present disclosure, it should be understood that the disclosed apparatus and method can be implemented in other ways. For example, the apparatus embodiments described above are only illustrative. For example, a division of units is only a logical function division, and there may be other divisions in actual implementations. For example, multiple units or components may be combined or may be integrated into another system, or some features may be ignored or not implemented. In addition, the displayed or discussed mutual coupling or direct coupling or communication connection may be indirect coupling or communication connection through some interfaces, devices or units, and may be in electrical, mechanical or other forms.

Units described as separate components may or may not be physically separated, and the components displayed as units may or may not be physical units, that is, they may be located in one place, or they may be distributed on multiple network units. Some or all of the units may be selected according to actual needs to achieve the objectives of the solutions of the embodiments.

In addition, functional units in the various embodiments of the present disclosure may be integrated into one processing unit, or each unit may exist alone physically, or two or more units may be integrated into one unit. The above-mentioned integrated unit may be implemented in a form of hardware, or may be implemented in a form of hardware plus software functional units.

The above-mentioned integrated unit implemented in the form of the software functional units may be stored in a computer readable storage medium. The above-mentioned software functional units are stored in a storage medium and include several instructions to make a computer device (which may be a personal computer, a server, or a network device, etc.) or a processor execute a part of the steps of the method described in the various embodiments of the present disclosure. The aforementioned storage media include: a U disk, a mobile hard disk, a read-only memory (ROM), a random access memory (RAM), a magnetic disk, an optical disk, or other media that can store program codes.

Those skilled in the art can clearly understand that, for the convenience and conciseness of the description, only a division of the above-mentioned functional modules is used as an example. In practical applications, the above-mentioned functions can be allocated by different functional modules as required, that is, the internal structure of the apparatus is divided into different functional modules to complete all or part of the functions described above. For a detailed working process of the apparatus described above, reference can be made to the corresponding process in the foregoing method embodiments, which is not repeated here.

It should be noted that the above embodiments are only used to illustrate the technical solutions of the present disclosure, not to limit them. Although the present disclosure has been described in detail with reference to the foregoing embodiments, those of ordinary skill in the art should understand that: the technical solutions recorded in the foregoing embodiments can still be modified, or some or all of the technical features can be equivalently replaced; and these modifications or replacements do not make the essence of the corresponding technical solutions deviate from the scope of the technical solutions of the embodiments of the present disclosure.

What is claimed is:

1. A control method for a photographing device mounted on a mobile platform, comprising:
obtaining photographing information of the photographing device and monitoring information of a target object, wherein the target object is a photographing object of the photographing device; and
in response to detecting a trigger event of identifying the target object, controlling a zoom operation of the photographing device according to the photographing information and the monitoring information, a size of the target object in an image acquired by the photographing device being controlled within a preset range according to the zoom operation.

2. The method according to claim 1, wherein controlling the zoom operation of the photographing device according to the photographing information and the monitoring information includes:
controlling the photographing device to stop zooming according to the photographing information and the monitoring information.

3. The method according to claim 2, wherein controlling the photographing device to stop zooming according to the photographing information and the monitoring information includes:
determining the size of the target object in the image according to the photographing information and the monitoring information; and
in response to that the size of the target object in the image is outside the preset range, controlling the photographing device to stop zooming.

4. The method according to claim 3, wherein:
the photographing information includes size information of the image, and the monitoring information includes size information of the target object in the image; and
determining the size of the target object in the image according to the photographing information and the monitoring information includes:
determining a size difference between the target object and the image according to the size information of the image and the size information of the target object in the image; and
in response to that the size difference is greater than a first threshold or the size difference is less than a second threshold, determining that the size of the target object in the image is outside the preset range.

5. The method according to claim 4, wherein:
the monitoring information includes size information of a selected area of the target object in the image, and at least a portion of the target object is located in the selected area.

6. The method according to claim 5, wherein:
the selected area is a rectangular area; and the size difference between the target object and the image includes at least one of a difference between a width of the selected area and a width of the image, or, a difference between a height of the selected area and a height of the image.

7. The method according to claim 3, wherein:
the photographing information includes area information of the image, and the monitoring information includes area information of the target object in the image; and
determining the size of the target object in the image according to the photographing information and the monitoring information includes:
determining an area difference between the target object and the image according to the area information of the image and the area information of the target object in the image; and
in response to that the area difference is greater than a third threshold or the area difference is less than a fourth threshold, determining that the size of the target object in the image is outside the preset range.

8. The method according to claim 7, wherein:
the monitoring information includes area information of a selected area of the target object in the image, and at least a portion of the target object is located in the selected area.

9. The method according to claim 2, wherein controlling the photographing device to stop zooming includes:
controlling the photographing device to stop executing a zoom instruction received by the photographing device, wherein the zoom instruction is configured to adjust a focal length of the photographing device.

10. The method according to claim 2, wherein after controlling the photographing device to stop zooming, the method further includes:
sending stop zooming prompt information to a control terminal, so that the control terminal prompts a user according to the stop zooming prompt information, wherein the control terminal is configured to control the mobile platform.

11. The method according to claim 1, wherein controlling the zoom operation of the photographing device according to the photographing information and the monitoring information includes:
controlling the photographing device to perform zooming according to the photographing information and the monitoring information.

12. The method according to claim 11, wherein controlling the photographing device to perform zooming according to the photographing information and the monitoring information includes:
controlling the photographing device to perform zooming to maintain the size of the target object in the image acquired by the photographing device according to the photographing information and the monitoring information.

13. The method according to claim 12, wherein:
the photographing information includes focal length information of the photographing device, and the monitoring information includes distance information between the target object and the mobile platform or the photographing device; and
controlling the photographing device to perform zooming according to the photographing information and the monitoring information includes:
determining a target focal length of the photographing device according to the focal length information and the distance information; and
adjusting a current focal length of the photographing device to the target focal length.

14. The method according to claim 13, wherein:
the focal length information includes a historical focal length of the photographing device at a historical moment; and the distance information includes a first distance of the target object relative to the mobile platform or the photographing device at the historical moment, and a second distance of the target object relative to the mobile platform or the photographing device at a current moment; and
determining the target focal length of the photographing device according to the focal length information and the distance information includes:
determining the target focal length of the photographing device according to the historical focal length, the first distance, and the second distance.

15. The method according to claim 14, wherein:
the historical moment is a moment when the mobile platform starts to follow the target object.

16. The method according to claim 14, wherein:
the historical moment is a moment when the size of the target object in the image is within the preset range.

17. The method according to claim 14, further comprising:
during a photographing process of the photographing device, in response to that a zoom instruction from the user is received, adjusting the current focal length of the photographing device according to the zoom instruction, and using the adjusted current focal length as the historical focal length.

18. A control apparatus for a photographing device, comprising:
a memory; and
a processor, wherein:
the memory is configured to store program codes; and
the processor calls the program codes, and when the program codes are executed, the processor is configured to perform:
obtaining photographing information of the photographing device and monitoring information of a target object, wherein the target object is a photographing object of the photographing device; and
in response to detecting a trigger event of identifying the target object, controlling a zoom operation of the photographing device according to the photographing information and the monitoring information, a size of the target object in an image acquired by the photographing device being controlled within a preset range according to the zoom operation.

19. A mobile platform, comprising:
a vehicle body;
a propulsion system, installed on the vehicle body and configured to provide propulsion;
a photographing device, configured to acquire images; and
a control apparatus for the photographing device, including:
a memory; and
a processor, wherein:
the memory is configured to store program codes; and
the processor calls the program codes, and when the program codes are executed, the processor is configured to perform:
obtaining photographing information of the photographing device and monitoring information of a target object, wherein the target object is a photographing object of the photographing device; and
In response to detecting a trigger event of identifying the target object, controlling a zoom operation of the photographing device according to the photographing information and the monitoring information, a size of the target object in an image acquired by the photographing device being controlled within a preset range according to the zoom operation.

20. The mobile platform according to claim 19, wherein:
the mobile platform includes at least one of: an unmanned aerial vehicle, a mobile robot, or a handheld gimbal.
